(19) United States
(12) Patent Application Publication
(10) Pub. No.: US 2021/0173457 A1
(43) Pub. Date: Jun. 10, 2021

(54) OPEN COMPUTE PROJECT CARD AUXILIARY MODE COOLING

(71) Applicant: Quanta Computer Inc., Taoyuan City (TW)

(72) Inventors: Yi-Chieh CHEN, Taoyuan City (TW); Yueh-Chang WU, Taoyuan City (TW); Jen-Mao CHEN, Taoyuan City (TW); Chih-Wei YANG, Taoyuan City (TW)

(21) Appl. No.: 16/707,913

(22) Filed: Dec. 9, 2019

(51) Int. Cl. G06F 1/20; G06F 1/3225; G06F 1/3296; G06F 11/30

(52) U.S. Cl. CPC G06F 1/206; G06F 11/3062; G06F 1/3296; G06F 1/3225

(57) ABSTRACT

An electronic device operating in standby mode is provided. The electronic device includes a power supply unit, a cooling device coupled to the power supply unit, at least one electronic component cooled by the cooling device, and a controller coupled to the cooling device. The controller is operable to periodically monitor power data and the temperature of the at least one electronic component in standby mode. The controller is also operable to regulate power supplied to the cooling device based on the monitored power data and the temperature of the at least one electronic component.

### FIELD OF THE INVENTION

The present disclosure relates generally to cooling systems for electronic devices, and more specifically, to a system for regulating cooling device power during standby mode.

### BACKGROUND

Electronic devices, such as servers, include electronic components that are connected to a power supply unit. Servers generate an enormous amount of heat due to the operation of the internal electronic components. These internal electronic components typically include controllers, processors, LAN cards, hard disk drives, and solid state disk drives. Overheating from the inefficient removal of such heat has the potential to shut down or impede the operation of the electronic components. Thus, servers are designed to rely on air flow through the interior of the device to carry away heat generated from the electronic components. Servers often include various heat sinks that are attached to the electronic components. Heat sinks are typically composed of thermally conductive material. Heat sinks absorb the generated heat from the electronic components and transfer the heat away from the components, often by permitting air flowing through or around the heat sink to absorb collected heat. This airflow is often generated by a fan system that accelerates air through or past the components and the heat sink. The generated airflow thus carries the collected heat away from the components and the heat sink. In some cases, heat can be extracted from components and heat sinks using other cooling devices, such as liquid cooling devices.

In typical servers, the system power for cooling such components is limited by the thermal design. Thus, the operating velocity of cooling devices is constrained by the thermal design, as components must sometimes be run at lower speeds so they don't overheat. By the principles of energy conversion, the power limitation of a fan cooled device is proportional to the air quantity flowing through the device. The greater the air quantity, the more air flow is available for cooling; and therefore, the performance of the system is increased. High system power allows for certain components, such as a CPU, to operate at higher clock speeds and/or higher power usage, thereby resulting in increased performance. Of course, greater air flow requires greater fan power, thereby increasing power requirements of the device. Various types of fans are used to provide adequate cooling. Moreover, different fan control mechanisms balance the cooling capacity and generated noise.

Since fan noise increases exponentially with fan rotation speed, reducing rotations per minute (RPM) by a small amount potentially results in a large reduction in fan noise. However, if the fan speed is reduced too much, components may overheat. One technique of modulating fan power is using a pulse width modulation control signal. Pulse width modulation (PWM) turns the power supply to fan-on and fan-off at a fixed frequency. Duty-cycle adjustments are made to control the speed of the fan. The larger the duty cycle, the faster the fan spins. A proper frequency must be selected since if the signal frequency is too slow, the fan's speed will noticeably oscillate within a PWM cycle. The frequency can also be too high, as commutation is done electronically using circuits that are powered by the fan's plus and minus terminals. Using PWM with the fan (and therefore the internal commutation electronics) too quickly can cause the internal commutation electronics to cease functioning correctly. In addition, the long-term reliability of the fan may be affected if the PWM rise and fall times are too fast. However, the cooling requirements for different components may vary. Such requirements are typically found in a product specification for the respective component, such as a processor, a circuit card, or a memory device.

Furthermore, the system power for cooling such components is limited by the system mode. In standby mode, most components are not functioning and therefore not generating heat. However, the Open Compute Project (OCP) 3.0 circuit card can consume substantial power and generate significant heat in standby mode. Standby power can be used for various functions, such as supporting wake-up functions (e.g., Wake-on-LAN), or supporting other standby functionality. When in standby mode, since active cooling devices are not powered, the OCP 3.0 circuit card is under natural convection cooling (e.g., without active airflow), thereby relying only on the natural rising of hot air and natural falling of cold air within the chassis. Further, other components in the system in standby mode or in nearby systems may produce heat that can lead to further heat build-up in the circuit card(s) of a system in standby mode. Therefore, such circuit cards may become hot from surrounding components and/or from their own standby functions. In present devices, the system fan will not power-on to cool down the OCP 3.0 circuit card when the system is in standby mode. Therefore, there is a need for a system to efficiently cool the OCP 3.0 circuit card when operating in standby mode.

### SUMMARY

An electronic device operating in standby mode is provided. The electronic device includes a power supply unit, a cooling device coupled to the power supply unit, an electronic component cooled by the cooling device, and a controller coupled to the cooling device. The controller is operable to periodically monitor power data and the temperature of the electronic component in standby mode. The controller is also operable to regulate power supplied to the cooling device based on the monitored power data and temperature of the electronic component.

In some embodiments, the electronic component is an Open Compute Project (OCP) 3.0 circuit card. The controller can be a management controller, such as a baseboard management controller, a power management controller, or a chassis management controller. The regulation of power to the cooling device can be based on a duty cycle of a pulse width modulation signal. The electronic device can also include a second cooling device. The controller can be operative to regulate the power supplied to the second cooling device based on cooling device performance of the cooling device coupled to the power supply unit. In some embodiments, the controller is operative to determine whether the electronic component is receiving power that exceeds a power dissipation requirement of the electronic component. The controller can also be operative to periodically monitor the power data and the temperature of the electronic component in standby mode every 10 seconds. In some embodiments, the controller can be operable to increase the power supplied to the cooling device where the temperature of the electronic component exceeds a predetermined temperature threshold.

A method to regulate cooling device operation to cool an electronic device in standby mode is also provided herein. The electronic device includes a power supply unit, a cooling device coupled to the power supply unit, and an electronic component in standby mode. The method includes storing system cooling information in a memory device; periodically monitoring power data and the temperature of the electronic component in standby mode; and regulating power supplied to the cooling device based on the monitored power data and temperature of the electronic component. The system cooling information includes requirements of the electronic component, requirements of the system, and/or capabilities of the cooling device.

Additional features and advantages of the disclosure will be set forth in the description that follows, and in part, will be obvious from the description; or can be learned by practice of the principles disclosed herein. The features and advantages of the disclosure can be realized and obtained by means of the instruments and combinations particularly pointed out in the appended claims. These and other features of the disclosure will become fully apparent from the following description and appended claims, or can be learned by the practice of the principles set forth herein.

### BRIEF DESCRIPTION OF THE DRAWINGS

In order to describe the manner in which the above-recited disclosure and its advantages and features can be obtained, a more particular description of the principles described above will be rendered by reference to specific examples illustrated in the appended drawings. These drawings depict only example aspects of the disclosure, and are therefore not to be considered as limiting of its scope. These principles are described and explained with additional specificity and detail through the use of the following drawings.

FIG. 1 is a top view of the electronic components of an example network device, such as a server, according to certain aspects of the present disclosure;

FIG. 2 is a top view of electronic components on a server that have different cooling requirements, according to certain aspects of the present disclosure;

FIG. 3 is a schematic diagram illustrating a process for cooling an OCP 3.0 circuit card during standby mode, according to certain aspects of the present disclosure; and

FIG. 4 is a flow chart illustrating a process for cooling an OCP 3.0 circuit card during standby mode, according to certain aspects of the present disclosure.

### DETAILED DESCRIPTION

The present invention is described with reference to the attached figures, where like reference numerals are used throughout the figures to designate similar or equivalent elements. The figures are not drawn to scale, and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details, or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

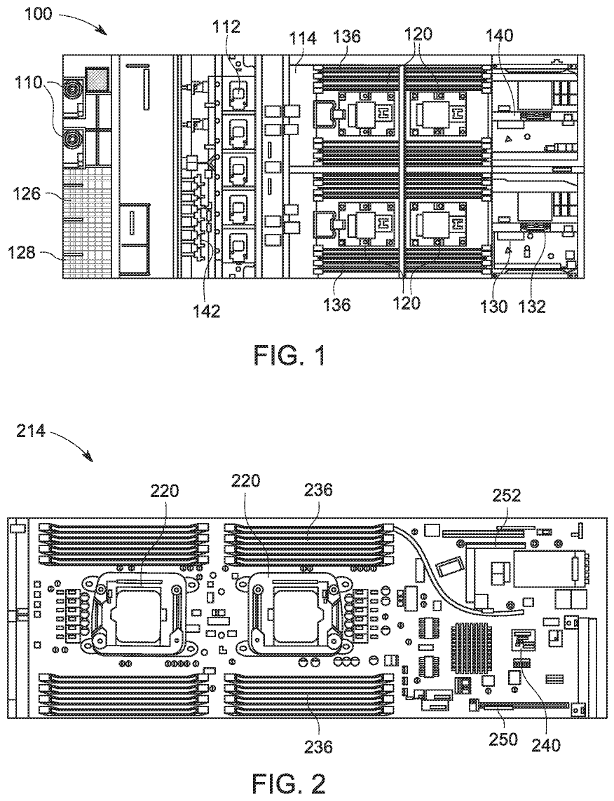

FIG. 1 is a top view of the electronic components of an example network device, such as a server 100, according to certain aspects of the present disclosure. The server 100 includes power supply units 110 and cooling devices 112. The power supply units 110 supply electrical power to different electronic components on the server 100. The server 100 includes numerous electronic components that are mounted on a motherboard 114. The electronic components generate heat when powered-on. The electronic components each have separate thermal cooling requirements to maintain operation. In this example, the electronic components include processors 120. Other components include a hard disk drive (HDD) 126, and a solid state disk drive (SSD) 128.

The server 100 includes device sockets for additional integrated circuits and slots for the insertion of circuit cards. Each such inserted component also generates heat and requires cooling to operate. In this example, other inserted components include a series of Peripheral Component Interconnect Express (PCIe) circuit cards 130 and a series of Open Compute Project (OCP 3.0) circuit cards 132 that are inserted in a respective slot. Optional devices such as a FPGA or a LAN card may be inserted in other device sockets. A series of DIMM memory devices 136 are also provided in sockets in proximity to the processors 120. The server can operate under three different power modes: a standby power mode, a cooling power mode as disclosed herein, and a full power mode. In some implementations of the disclosure, the server 100 can receive 12 volts of power in standby power mode. The cooling power stage can direct power (e.g., 12 volts) towards a cooling device. In the full power mode, all of systems within the server 100 are fully powered.

The server 100 also includes a baseboard management controller (BMC) 140 that monitors power data and other support for the electronic components of the server 100. The server also includes a chassis management controller CMC 142 that controls the output from the power supply unit 110 and the cooling device 112. There may be multiple electronic components of the same type. For example, the motherboard 114 of the server 100 may include additional sockets or slots for receiving additional components such as processors, cards, memory devices, and the like. The different configurations of possible electronic components that may be installed in the server 100 each have different thermal cooling requirements.

FIG. 2 is a top view of electronic components of a server that have different cooling requirements, in accordance with an implementation of the disclosure. The motherboard 214 can be similar to the motherboard 114 of FIG. 1 and can be used in the server 100 of FIG. 1. As may be seen in FIG. 2, the server includes numerous electronic components that are mounted on a motherboard 214. The electronic components generate heat when powered-on. The electronic components each have separate thermal cooling requirements to maintain operation. In this example, the electronic components include processors 220. A series of DIMM memory devices 236 are also provided in sockets in proximity to the processors 220. The mother-board 214 also includes open PCIe slots 250 and OCP slots 252 that allow for the addition of other components that change the thermal cooling requirements of the server. As will be explained below, in this example, the BMC 240 and CMC (e.g., the CMC 142 of FIG. 1) allow for the adjustment of power for the cooling devices (e.g., cooling devices 112 of FIG. 1) to optimize cooling, and adapt the cooling level when in standby mode. It should be understood that the cooling device 112 can include any type of cooling device, for example, a fan or a liquid cooling device. It should also be understood that any suitable controller with appropriate software or firmware may allow for adjustment of the cooling devices, according to the principles explained below.

Each of the different product specifications for different components—such as processors, memory devices, and cards—includes thermal requirements for cooling. In the present example, different techniques may be applied for adjusting cooling device power levels to provide for efficient cooling of the OCP 3.0 circuit cards (e.g., OCP 3.0 circuit cards 132 of FIG. 1) in standby mode. By software or a firmware assisted cooling mechanism, the cooling device speed may be defined for the OCP 3.0 circuit cards. The cooling device speed may be used to control the power to the cooling devices, and therefore result in power saving and reducing acoustical vibration from excessive cooling device operation. In an example, fans (e.g., cooling devices 112 of FIG. 1) are grouped together in two fan zones, thereby allowing for more targeted cooling and associated power settings. Thus, the same fan speed is used for two fans in a first fan zone, while a different fan speed may be used for two fans in a second fan zone. Of course, with different organization, the fan speeds for each of the fans may be controlled separately.

Generally, an operating memory of the controller that performs the below routine includes a supported components list that is created based on thermal limitations of the electronic components that may be installed on the devices. Some of components are hard to cool due to high power dissipation and strict thermal requirements. Other components are easier to cool because of low power dissipation and less strict thermal requirements. As a result, each component, including the OCP 3.0 circuit cards, has a specific power dissipation requirement that would indicate the thermal limitations.

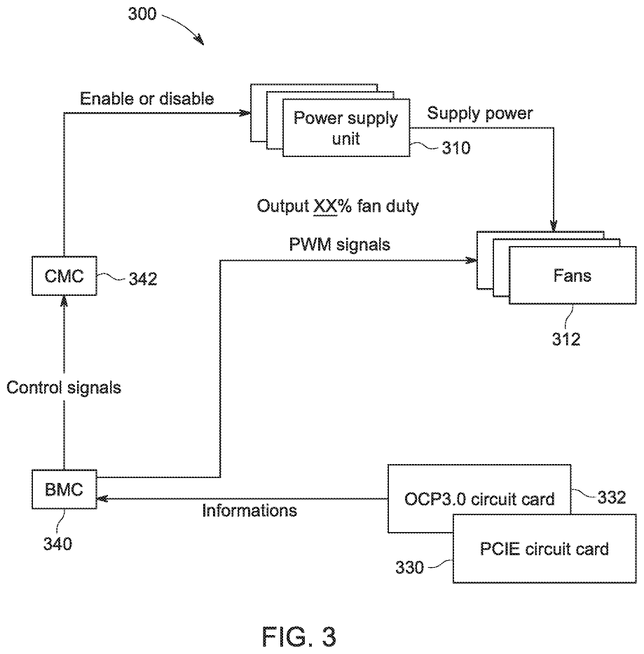

FIG. 3 is a schematic diagram illustrating a process 300 for cooling an OCP 3.0 circuit card 332 during standby mode, in accordance with an embodiment of the disclosure. The cooling process via firmware or software may be performed in a variety of ways. One example of such cooling process is shown in FIG. 3 for cooling an OCP 3.0 circuit card 332 (e.g., the OCP 3.0 circuit card 132 of FIG. 1) and a PCIe circuit card 330 (e.g., the PCIe circuit card 130 of FIG. 1) in standby mode. Process 300 can be performed using a sever, such as server 100 of FIG. 1.

In the example depicted in FIG. 3, standby mode (or auxiliary mode) is recognized where the server is between receiving alternative current (“AC on”) and receiving direct current (“DC on”). Standby mode can also be recognized as a complete power-off (“DC off”). During the standby mode the cooling devices 312 are typically powered-off. In some instances, the OCP 3.0 circuit card 332 receives standby power when the server is in standby mode. As generally understood, standby power refers to the electric power consumed by electronic components while they are switched-off (but are designed to draw some power) or in standby mode.

Once the server is in standby mode, the BMC 340 determines if the OCP 3.0 circuit cards 332 are receiving power. If the BMC 340 determines the OCP 3.0 circuit cards 332 are receiving power, the BMC 340 determines the specific power dissipation requirement of the OCP 3.0 circuit cards 332. If the power received by the OCP 3.0 circuit cards 332 is less than the specific power dissipation requirement, the cooling devices 312 remain powered-off.

Alternatively, if the power received by the OCP 3.0 circuit cards 332 is determined to be more than the specific power dissipation requirement, the BMC 340 directs the CMC 342 to actuate the power supply unit 310 to enter the cooling power mode as described herein. The BMC 340 periodically monitors the power data and the temperature of the OCP 3.0 circuit cards 332. In some embodiments, the BMC 340 monitors the temperature of the OCP 3.0 circuit cards 332 every ten seconds. Once the temperature of the OCP 3.0 circuit cards 332 exceeds a predetermined threshold, the BMC 340 directs the CMC 342 to actuate the power supply unit 310 to enter the cooling power mode as described herein. The BMC 340 periodically monitors anywhere between once every second to once every 60 seconds, but can be less frequent. The periodic monitoring can also exceed once every 60 seconds, for example, when in standby the BMC 340 periodically monitors every several minutes or hours. In some cases, the BMC 340 can monitor at a first rate when the system is in a standby power mode, but can monitor at a second rate (e.g., more or less frequent than the first rate) when in a cooling power mode. In some cases, the monitoring rate of the BMC 340 can be dependent on the temperature of the circuit card (e.g., the OCP 3.0 circuit cards 332) and/or the power data associated with the circuit card (e.g., the OCP 3.0 circuit cards 332).

In the cooling power mode, the CMC 342 directs the power supply unit 310 to output power to the cooling devices 312 to cool the OCP 3.0 circuit cards 332. In this cooling power mode, the system can use more power than when in a standby power mode, but still less power than when in a full power mode. The BMC 340 can also regulate the cooling power of the cooling devices 312 (e.g., by regulating the PWM of the cooling devices 312) based on cooling device performance and the monitored temperature of the OCP 3.0 circuit cards 332. For example, in the event a first cooling device 312 malfunctions, the cooling device speed of a second cooling device 312 in the same cooling device zone can be increased to account for the malfunction of the first cooling device 312.

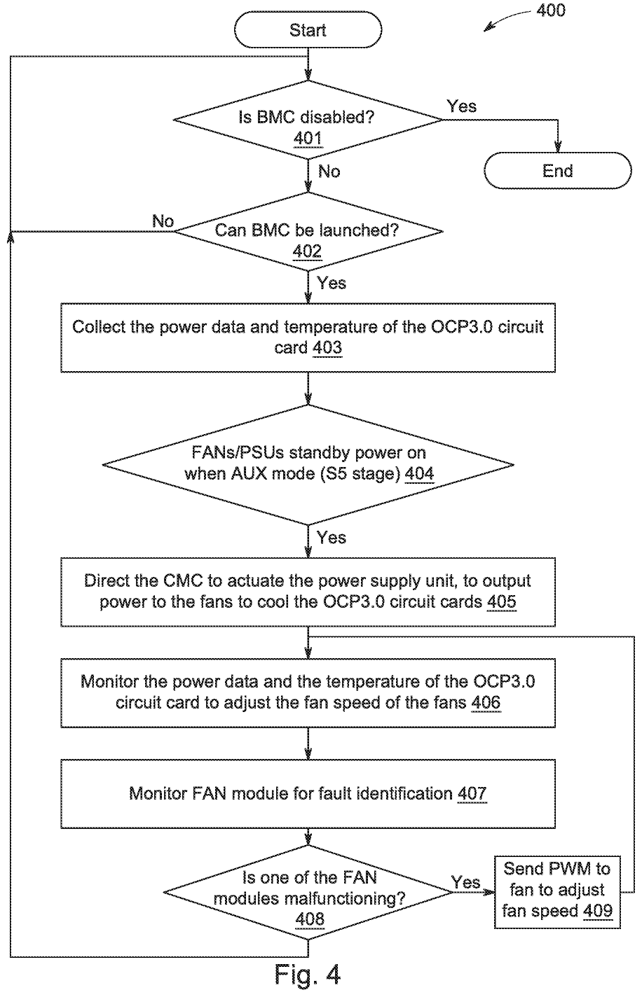

FIG. 4 is a flow chart illustrating a process 400 for cooling an OCP 3.0 circuit card (e.g., the OCP 3.0 circuit card 132 of FIG. 1) during standby mode, in accordance with an embodiment of the disclosure. Process 400 can be used with a server, such as the server 100 of FIG. 1. The corresponding cooling device control data is stored in a memory, such as the internal memory of the BMC. The status of the BMC is first determined at steps 401 and 402. An initial inquiry is made as to whether the BMC is disabled at step 401. At step 402, an inquiry is made as to whether the BMC can be launched. If the BMC is disabled, process 400 ends. If the BMC cannot be launched, process 400 returns to step 401, where it is determined whether the BMC is disabled. Alternatively, if the BMC can be launched at step 402, process 400 repeats at step 403.

At step 403, the BMC collects the power data and temperature of the OCP 3.0 circuit card. It should be understood that the BMC is configured to collect the server configuration requirements, and specifically, the power dissipation requirements of all the electronic components on board. At step 404, the BMC determines if the cooling devices are receiving power from the power supply unit in standby mode.

If it is determined that the cooling devices are not receiving power from the power supply unit in standby mode, the process advances to step 405. At step 405, the BMC directs the CMC to actuate the power supply unit. The CMC directs the power supply unit to output power to the cooling devices to cool the OCP 3.0 circuit cards.

At step 406, the BMC monitors the power data and the temperature of the OCP 3.0 circuit cards to adjust the cooling device speed of the cooling devices. At step 407, the BMC also monitors the cooling device for fault identification. A determination is made at step 408 as to whether the cooling device malfunctioned. In the event the cooling device malfunctioned, the process advances to step 409 where the BMC is configured to send PWM signals to the cooling device. In this case, the cooling device speed for a second cooling device can be increased to account for the cooling loss of the malfunctioned cooling device.

The advantages of correlating cooling device behavior with the status of the OCP 3.0 circuit card, as compared to traditional solutions, include power saving and enhanced performance of the during operation of the device.

The processes 300, 400 of FIGS. 3 and 4, respectively, are representative of example machine readable instructions for a BMC and CMC (e.g., the BMC 140 and the CMC 142 of FIG. 1) to set the cooling device power level. In these examples, the machine readable instructions comprise an algorithm for execution by: (a) a processor; (b) a controller; and/or (c) one or more other suitable processing device(s). The algorithm may be embodied in software stored on tangible media such as a flash memory, a CD-ROM, a floppy disk, a hard drive, a digital video (versatile) disk (DVD), or other memory devices. However, persons of ordinary skill in the art will readily appreciate that the entire algorithm and/or parts thereof can alternatively be executed by a device other than a processor and/or embodied in firmware or dedicated hardware in a well-known manner (e.g., it may be implemented by an application specific integrated circuit (ASIC); a programmable logic device (PLD); a field programmable logic device (FPLD); a field programmable gate array (FPGA); discrete logic; etc.). For example, any or all of the components of the interfaces can be implemented by software, hardware, and/or firmware. Also, some or all of the machine readable instructions represented by the processes 300, 400 of FIGS. 3 and 4, respectively, may be implemented manually. Further, although the example algorithm is described with reference to the processes 300, 400 illustrated in FIGS. 3 and 4, respectively, persons of ordinary skill in the art will readily appreciate that many other methods of implementing the example machine readable instructions may alternatively be used. For example, the order of execution of the blocks may be changed, and/or some of the blocks described may be changed, eliminated, or combined.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Numerous changes to the disclosed embodiments can be made in accordance with the disclosure herein, without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

What is claimed is:

1. An electronic device, comprising:
a power supply unit;
a cooling device coupled to the power supply unit;
at least one electronic component cooled by the cooling device; and
a controller coupled to the cooling device, the controller operable to:
periodically monitor power data and temperature of the at least one electronic component when the at least one electronic component is not operating in a full power mode; and
regulate power supplied to the cooling device based on the monitored power data and the monitored temperature of the at least one electronic component.

2. The electronic device of claim 1, wherein the at least one electronic component is an Open Compute Project (OCP) circuit card.

3. The electronic device of claim 1, wherein the at least one electronic component is an accessory card.

4. The electronic device of claim 1, wherein the controller is a management controller.

5. The electronic device of claim 1, wherein the controller is further operable to receive cooling requirement information from the at least one electronic component, and wherein regulating power supplied to the cooling device is further based on the received cooling requirement information.

6. The electronic device of claim 1, further comprising an additional cooling device, wherein the controller is further operable to regulate power supplied to the additional cooling device based on cooling device performance of the cooling device coupled to the power supply unit.

7. The electronic device of claim 6, wherein the cooling device performance is determined based on temperature of the at least one electronic component.

8. The electronic device of claim 6, wherein the cooling device performance is determined based on cooling requirements and airflow information of the at least one electronic component.

9. The electronic device of claim 6, wherein the controller is further operable to detect a failure of the cooling device, and wherein the power supplied to the additional cooling device is regulated based on the detected failure.

10. The electronic device of claim 9, wherein the failure of the cooling device is detected by a rising temperature of the at least one electronic component or from the cooling device operating below a threshold number of revolutions per minute.

11. The electronic device of claim 1, wherein the controller is further operable to determine if the at least one electronic component is receiving power that exceeds a power dissipation requirement of the at least one electronic component, and wherein regulating power supplied to the cooling device is further based on the information that the at least one electronic component is receiving power that exceeds the power dissipation requirement.

12. The electronic device of claim 11, wherein the power received by the at least one electronic component is detected via current meter on power node.

13. The electronic device of claim 1, wherein periodically monitoring the power data and the temperature of the at least one electronic component comprises periodically monitoring the power data and the temperature of the at least one electronic component in a standby mode every 1-60 seconds.

14. The electronic device of claim 1, wherein the controller is further operable to increase the power supplied to the cooling device in response to the temperature of the at least one electronic component exceeding a predetermined temperature threshold.

15. A method to regulate cooling device operation to cool an electronic device, the electronic device including a power supply unit, a cooling device coupled to the power supply unit, and at least one electronic component, the method comprising:
storing system cooling information in a memory device;
periodically monitoring power data and temperature of the at least one electronic component; and
regulating power supplied to the cooling device based on the monitored power data and the monitored temperature of the at least one electronic component and the system cooling information.

16. The method of claim 15, wherein the at least one electronic component is an Open Compute Project (OCP) circuit card.

17. The method of claim 15, wherein the controller is a management controller.

18. The method of claim 15, further comprising receiving cooling requirement information from the at least one electronic component, and wherein regulating power supplied to the cooling device is further based on the received cooling requirement information.

19. The method of claim 15, further comprising detecting a failure of the cooling device, and regulating power supplied to the additional cooling device based on the detected failure.

20. The method of claim 15, further comprising detecting a failure of the cooling device by detecting a rising temperature of the at least one electronic component or by detecting the cooling device operating below a threshold number of revolutions per minute.
